(19) United States
(12) Patent Application Publication
(10) Pub. No.: US 2016/0337712 A1
(43) Pub. Date: Nov. 17, 2016

(54) DISPLAY APPARATUS AND METHOD OF CONTROLLING DISPLAY APPARATUS THEREOF

(71) Applicant: SAMSUNG ELECTRONICS CO., LTD., Suwon-si (KR)

(72) Inventors: Ki-mo AN, Seongnam-si (KR); Cheol-ju HWANG, Yongin-si (KR); Ji-young SONG, Suwon-si (KR)

(73) Assignee: SAMSUNG ELECTRONICS CO., LTD., Suwon-si (KR)

(21) Appl. No.: 15/091,091

(22) Filed: Apr. 5, 2016

(30) Foreign Application Priority Data
May 15, 2015 (KR) 10-2015-0068266

(51) Int. Cl. H04N 21/81; H04N 5/445; H04N 21/458; H04N 21/4722; H04N 21/431; H04N 21/45; H04N 5/44; H04N 21/422

(52) U.S. Cl. CPC H04N 21/8173; H04N 5/4403; H04N 5/44591; H04N 21/4221; H04N 21/4722; H04N 21/4316; H04N 21/4532; H04N 21/4586; H04N 2005/4412

(57) ABSTRACT

A display apparatus and a method of controlling the display apparatus are provided. The display apparatus includes a display, a communication unit, and a processor. The display is configured to display content. The communication unit is configured to communicate with an external apparatus and a remote controller. When the communication unit receives a first signal corresponding to a user command being received at the remote controller, the processor controls the communication unit to transmit to the external apparatus a second signal comprising the user command and context information regarding the content. In response to receiving, from the external apparatus, application information which indicates an application to be executed, the processor executes the application.

### CROSS-REFERENCE TO RELATED APPLICATIONS

This application claims priority from Korean Patent Application No. 10-2015-0068266, filed in the Korean Intellectual Property Office on May 15, 2015, the disclosure of which is incorporated herein by reference.

### BACKGROUND

1. Field

Apparatuses and methods consistent with exemplary embodiments relate to a display apparatus and a method of controlling the display apparatus, and more particularly, to a display apparatus which is controlled by a remote controller including a predetermined button for executing a specific application and a method of controlling the display apparatus.

2. Description of the Related Art

A recent display apparatus provides various functions and services. As the number of functions and services provided by a display apparatus increases, the number buttons on a remote controller which controls the display apparatus may also increase.

The buttons on a remote controller may include not only buttons to control broadcast-related functions of the display apparatus but also buttons to control various functions and execute applications.

Specifically, when a predetermined button on the remote controller is selected, the display apparatus may execute a service or an application corresponding to the predetermined button. In this case, the correspondence between the application or the service and the predetermined button is usually pre-stored and thus, it may not be possible to assign the predetermined button to a new function, service, or application. Thus, if the pre-designated service is changed or no longer in service at a later date, the corresponding button may lose its functionality, which may cause problems.

### SUMMARY

One or more exemplary embodiments relate to a display apparatus which, if a predetermined button on a remote controller is selected, transmits an event signal to an external server, and if application information is received from an external server, executes an application corresponding to the application information and a method of controlling the display apparatus.

According to an aspect of an exemplary embodiment, there is provided a display apparatus including a display configured to display content such as an image or a movie; a communication unit configured to communicate with an external apparatus, such as a server, and a remote controller; and a processor configured to, in response to the communication unit receiving a first signal corresponding to a user command being received at the remote controller, control the communication unit to transmit to the external apparatus a second signal comprising the user command and context information regarding the content, and in response to application information being received from the external apparatus, execute an application indicated in the application information.

The processor, in response to a predetermined user interface element, such as a button, on the remote controller being activated while the image is displayed, may control the display to display an execution screen of the application alongside or as part of the image.

The second signal may be an event signal and may include information regarding the image which is currently displayed, and the application information may be determined based on information regarding the image which is currently displayed.

The application information may be determined based on a search record or a viewing record of a user who uses the display apparatus.

The application information may be changed or updated at one or more predetermined time periods by the server.

The application information may include identification information and version information of the application.

The processor may determine whether an application corresponding to the application information is installed on the display apparatus based on the application identification information. In response to the application corresponding to the application information not being installed on the display apparatus, the processor may request the external apparatus to provide data regarding the application corresponding to the application information. Subsequently, in response to the data regarding the application being received in response to the request, the processor may install the application.

The processor may determine whether a version of the application which is currently installed is a latest version based on the version information of the application. In response to the version of the currently-installed application not being the latest version, the processor may request the external apparatus to provide data regarding the latest version of the application. In addition, in response to the data regarding the application of the latest version being received, the processor may update the currently-installed application to the latest version.

According to an aspect of another exemplary embodiment, there is provided a method of controlling a display apparatus which is controlled by a remote controller. The method includes, in response to a predetermined user interface element, such as button, on the remote controller being activated, transmitting an event signal to a server, and in response to application information being received from the external server, executing an application corresponding to the application information.

The method may further include displaying an image, and the execution of the application may include displaying an execution screen of the application as part of the image.

The event signal may include information regarding the image which is currently displayed, and the application information may be determined based on information regarding the image which is currently displayed.

The application information may be determined based on a search record or a viewing record of a user who uses the display apparatus.

The application information may be changed or updated at a predetermined time or time period by the server.

The application information may include identification information or version information of the application.

The method may further include determining whether an application corresponding to the application information is installed based on the application identification information. In response to the application corresponding to the application information not being installed, the server may be requested to provide data regarding the application, and in response to the data regarding the application being received in response to the request, the application may be installed.

The method may include determining whether a version of the application which is currently installed is a latest version based on version information of the application. In response to the version of the currently-installed application not being the latest version, the server may be requested to provide data regarding the latest version of the application, and in response to the data regarding the application of the latest version being received, the currently-installed application may be updated to the latest version.

### BRIEF DESCRIPTION OF THE DRAWINGS

The above and/or other aspects of the present inventive concept will be more apparent by describing certain exemplary embodiments of the present inventive concept with reference to the accompanying drawings, in which:

FIG. 1 is an illustration of a service providing system according to an exemplary embodiment;

FIG. 2 is a simplified block diagram illustrating a configuration of a display system according to an exemplary embodiment;

FIG. 3 is a detailed block diagram illustrating a configuration of a display system according to an exemplary embodiment;

FIG. 4 is an illustration of a remote controller according to an exemplary embodiment;

FIGS. 5A-5B are illustrations of various exemplary embodiments for executing an application;

FIGS. 6A-6C are illustrations of various exemplary embodiments for executing an application;

FIG. 7 is an illustration of an exemplary embodiment for executing an application;

FIGS. 8A-8B are illustrations of various exemplary embodiments for executing an application;

FIG. 9 is a block diagram illustrating a configuration of a server according to an exemplary embodiment;

FIG. 10 is a flowchart of a method of controlling a display apparatus according to an exemplary embodiment; and

FIG. 11 is a sequence diagram illustrating a method of controlling a service providing system according to an exemplary embodiment.

### DETAILED DESCRIPTION OF EXEMPLARY EMBODIMENTS

The exemplary embodiments may vary, and may be provided in different exemplary embodiments. Specific exemplary embodiments will be described with reference to accompanying drawings and detailed explanation. However, this does not necessarily limit the scope of the exemplary embodiments to a specific embodiment form. Instead, modifications, equivalents and replacements included in the disclosed concept and technical scope of this specification may be employed. While describing exemplary embodiments, if it is determined that the specific description regarding a known technology obscures the gist of the invention, the specific description is omitted.

In the present disclosure, relational terms such as first, second, and the like, may be used to distinguish one entity from another entity, without necessarily implying any actual relationship or order between such entities.

The terms used in the following description are provided to explain a specific exemplary embodiment and are not intended to limit the scope of rights. A singular term includes a plural form unless it is intentionally written that way. The terms, “include,” “comprise,” “is configured to,” etc. of the description are used to indicate that there are features, numbers, steps, operations, elements, parts or combination thereof, and they should not exclude the possibilities of combination or addition of one or more features, numbers, steps, operations, elements, parts or combination thereof.

In an exemplary embodiment, ‘a module’ or ‘a unit’ performs at least one function or operation, and may be realized as hardware, software, or combination thereof. In addition, a plurality of ‘modules’ or a plurality of ‘units’ may be integrated into at least one module and may be realized as at least one processor (not shown) except for ‘modules’ or ‘units’ that should be realized in a specific hardware.

Hereinafter, exemplary embodiments will be described in greater detail with reference to the accompanying drawings, and the same or corresponding element will be given the same reference numeral, and overlapping description thereof will not be provided.

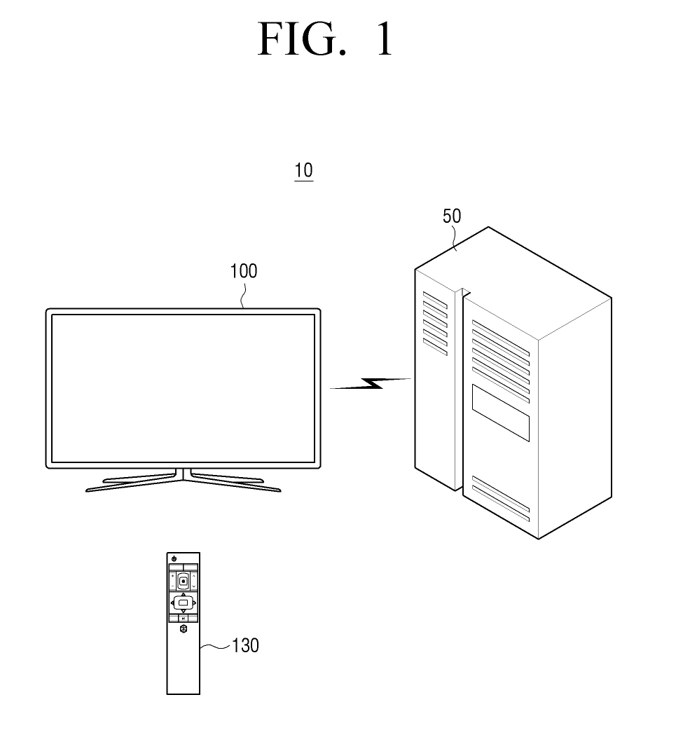

FIG. 1 is an illustration of a service providing system 10 according to an exemplary embodiment. As illustrated in FIG. 1, the service providing system 10 includes a display apparatus 100, a remote controller 130 to control the display apparatus 100 and a server 50. In this case, the display apparatus 100 can be a smart TV with integrated Internet communication capabilities, but the display apparatus 100 can also be a conventional television without such capabilities. The display apparatus 100 may also be a desktop computer, a laptop computer, a tablet computing device, a mobile device, a smartphone, a digital TV, a kiosk, etc. In addition, the remote controller 130 may be a general purpose remote controller or a programmable remote controller. The remote controller 130 may be other user input devices such as a pointing device, a clicker, a mouse, a joystick, a mobile phone, a tablet, a mobile device, etc. The remote controller 130 can be wireless or tethered to the display apparatus 100 via electric cabling. The remote controller 130 can transmit signals to the display apparatus 100 in a number of ways including via infrared, radio waves, Wi-Fi, Bluetooth, near field communication (NFC), and other wired or wireless communication protocols.

The remote controller 130 may include means to receive various user commands from the user, such as buttons, knobs, toggles, etc. One of the user commands can be a predetermined command to execute an application or service. As used herein, the term “predetermined command” may mean that the command itself (e.g., a code signal “0105”) can be determined at a time preceding the activation of the respective user interface element, but which action the signal causes the display apparatus 100 to perform (e.g., which application to launch) may not necessarily be determined at this time. The predetermined command can be received by the remote controller 130 when the user selects or activates a predetermined user interface element of the remote controller 130. The predetermined user interface element can be part of a physical user interface implemented with hardware or a virtual user interface implemented with software. For example, the predetermined user interface element can be a button, a switch, a slider, a knob, a toggle, a touch gesture, a radio button, etc. In addition, the predetermined user command can be received via a specific voice command in case the remote controller 130 is capable of voice recognition or a gesture command in case the remote controller 130 is capable of gesture/motion recognition. For example, the predetermined user command may correspond to a “video-on-demand” voice command.

When the predetermined user command is received at the remote controller 130 from the user, the remote controller 130 can transmit a signal indicating the user command to the display apparatus 100. The user may issue the predetermined user command by depressing, touching, flipping, releasing, swiping, hovering over, or clicking on the predetermined user interface element such as a button, etc. Alternatively, the predetermined user command can be issued by speaking a predetermined voice command or performing a predetermined gesture command to the remote controller 130. In response to the predetermined user command being received at the remote controller 130, the display apparatus 100 may generate an event signal. In this case, the event signal may include information regarding an audiovisual content which is displayed on the display apparatus 100 at the time the user command is received. The event signal may also include user information associated with the user who made the selection. The display apparatus 100 may transmit the event signal to a server 50.

The server 50 can be an external server, meaning that it is physically a separate entity from the display apparatus 100 and that it is possibly situated at a remote location from the display apparatus 100. However, in some embodiments, the server 50 can be part of the display apparatus 100. The server 50 may also be substituted with any other external apparatuses such as a desktop computer, a laptop computer, a mobile device, a tablet device, a mobile phone, etc. The display apparatus 100 may communicate with the server 50 via a network (not shown) such as a local area network (LAN) or a wide area network (WAN) such as the Internet. The server 50 may generate application information response to the received event signal. Specifically, the server 50 may analyze the received event signal and generate application information that includes various information, such as application identification (ID) information and application version information, regarding an application to be provided to a user. The application identification information may be any piece of information that can uniquely identify the application. The server 50 may determine the application to be provided to the user of the display apparatus 100 based on not only the content information and user information included in the event signal but also any other available information about applications to be recommended. For example, the server 50 may maintain a list or table of available applications and corresponding rules for recommending the applications based on various conditions, user preferences, related contents, etc.

When the display apparatus 100 receives the application information from the server 50, the display apparatus 100 may execute the application that corresponds to the application information. Specifically, if the application corresponding to the application information is already installed on the display apparatus 100, the display apparatus 100 may execute the application immediately. However, if the application corresponding to the application information is not installed on the display apparatus 100 or the installed application is not an acceptable version, the display apparatus 100 may first install the application or update the application to an appropriate version based on the application information before executing the application. For instance, the acceptable version, as may be dictated by the server 50, can be the latest version (e.g., ver. 11.1.4), a specific version (e.g., ver. 10.2.9), or a range of versions (e.g., ver. 4.1.6 through ver. 8.2.6).

As described above, as the user issues a predetermined user command to the remote controller 130 by, for example, pressing a predetermined button, the service providing system 10 may provide the user with an optimized application.

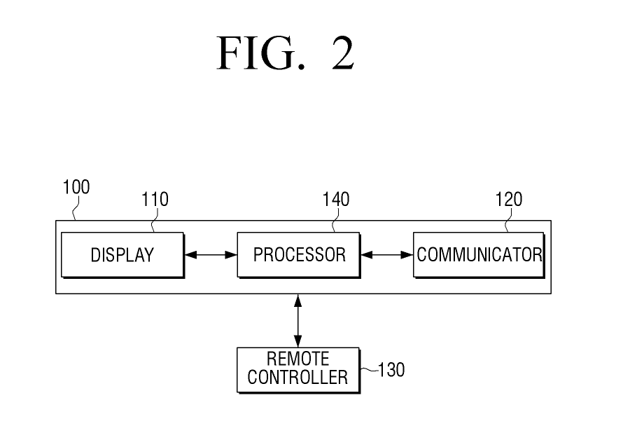

Hereinafter, the display apparatus 100 will be described in greater detail with reference to FIGS. 2 to 8B.

FIG. 2 is a simplified block diagram illustrating a configuration of a display apparatus 100 according to an exemplary embodiment.

As illustrated in FIG. 2, the display apparatus 100 may include a display 110, a communicator 120, and a processor 140 (also referred to as “a controller”). The display apparatus 100 may also include an audio output module (not shown) such as one or more speakers capable of presenting audio content. The display apparatus 100 can communicate, for instance via the communicator 120, with an external input device such as a remote controller 130.

The display 110 may be capable of displaying an image or visual content. The display 110 may be similar to the display apparatus 100 shown in FIG. 1. In particular, if a predetermined user command is received at the remote controller 130 is selected, the display 110 may display the visual content along with an application execution screen that corresponds to the predetermined user command.

The communicator 120 (also referred to as “communication unit”) may perform communication with an external apparatus such as a server. In particular, the communicator 120 may transmit an event signal to the server 50 or receive application information from the server 50.

The remote controller 130 may include a plurality of user interface elements such as buttons, toggles, switches, sliders, microphones, cameras, etc., and receive a user command through the plurality of user interface elements. In particular, the remote controller 130 may include a predetermined button (e.g., an “Extra” button, etc.) to execute a specific application or service. For example, the predetermined button on the remote controller 130 may be labeled “Streaming Videos,” and when the user activates this button, an application related to a video streaming service, such as Netflix®, Hulu®, or Vudu®, may be launched.

Furthermore, the processor 140 may control the overall operations of the display apparatus 100. In particular, if a predetermined user command is received at the remote controller 130, the processor 140 may control the communicator 120 to transmit an event signal to the server 50. Upon receiving application information from the server 50, the processor 140 may execute an application that corresponds to the application information. For example, the application information received from the server 50 may indicate the application to be executed is an Netflix® application. If Netflix® is temporarily or permanently out of service at the moment, the application information may indicate an alternative application is to be executed such as Hulu®.

Moreover, if a predetermined user command is received at the remote controller 130 while the display 110 is displaying a specific audiovisual content, the processor 140 may generate the event signal specifically based on such audiovisual content. In this case, the processor 140 may generate the event information including at least one of information regarding the content currently being displayed and user information related to the user.

The processor 140 may control the communicator 120 to transmit the generated event signal to the server 50. In this case, the server 50 may generate application information based on information regarding the displayed content on the display 10, information related to the user, rules governing application recommendations, etc. retrieved from the event information or elsewhere. In addition, the server 50 may generate the application information further based on a search record and/or a viewing record of one or more users who use the display apparatus. 100. The search record can be, for example, a history of past searches performed on the display apparatus 100. Similarly, the viewing record can be a history of audiovisual content accessed by the users of the display apparatus 100. For example, the server 50 may generate the application information based on television programs or movies that the users of the display apparatus 100 have watched or searched for in the past. Thus, depending on what is currently showing on the display 110, a predetermined button or command that is labeled “Action” may trigger a shopping application for buying an item of clothing displayed on the display 110, an email application for composing an email to the address displayed on the display apparatus 100, or a reference application for looking up the bio of an actress currently shown in the display apparatus 100. The server 50 may change or update application information at a predetermined time period and transmit the application information. For instance, the server 50 can cycle through multiple applications throughout the week depending on what day of the week it is. In another instance, the server 50 can include one application in the application information for three months, after which the server 50 includes another application in the application information.

If application information corresponding to an event signal is received from the server 50, the processor 140 may execute an application that corresponds to the application information, and control the display 110 to display an execution screen of the application. The execution screen may be displayed along with any preexisting content displayed on the display 110. For example, the execution screen may be overlayed on top of or displayed side-by-side alongside the preexisting audiovisual content. The execution screen may also be displayed as a picture-in-picture insert.

Specifically, the application information transmitted from the server 50 may include application ID information and/or application version information. The processor 140 may determine, based on the application ID information, whether an application corresponding to the application information is properly installed on the display apparatus 100. If it is determined that the application corresponding to the application information is not installed on the display apparatus 100, the processor 140 may control the communicator 120 to request the server 50 to provide data regarding the application. Upon receiving the data regarding the application from the server 50 in response to the request, the processor 140 may install the application on the display apparatus 100 and execute the application. The application may be installed on a computer-readable storage medium or device (not shown) that is controlled by the processor 140. The computer-readable storage medium or device can be any available media that can be accessed by a general-purpose or special purpose computer or processor, including random access memory (RAM), read-only memory (ROM), electrically erasable programmable read-only memory (EEPROM), flash memory, compact disc (CD-ROM) or other optical disk storage, hard disk drive (HDD) or other magnetic disk storage devices, solid-state drive (SSD) or other semiconductor-based storage devices, or any other device or medium which can be used to carry or store desired program code in the form of computer-executable instructions, data structures, or processor chip design.

If it is determined that the application corresponding to the application information is already installed on the display apparatus 100, the processor 140 may further determine, based on the application version information, whether the version of the installed application is an appropriate version. The appropriate version may be the latest version, one or more specific versions, or a range of versions. If the version of the currently-installed application is not an appropriate version, the processor 140 may request the server 50 to provide data regarding the appropriate version of the application. Upon receiving the data regarding the appropriate version from the server 50, the processor 140 may update the currently-installed application to an appropriate version such as the latest version available. Thus, according to the above-described exemplary embodiments, a user may be provided with an application more conveniently and accurately optimized for her needs.

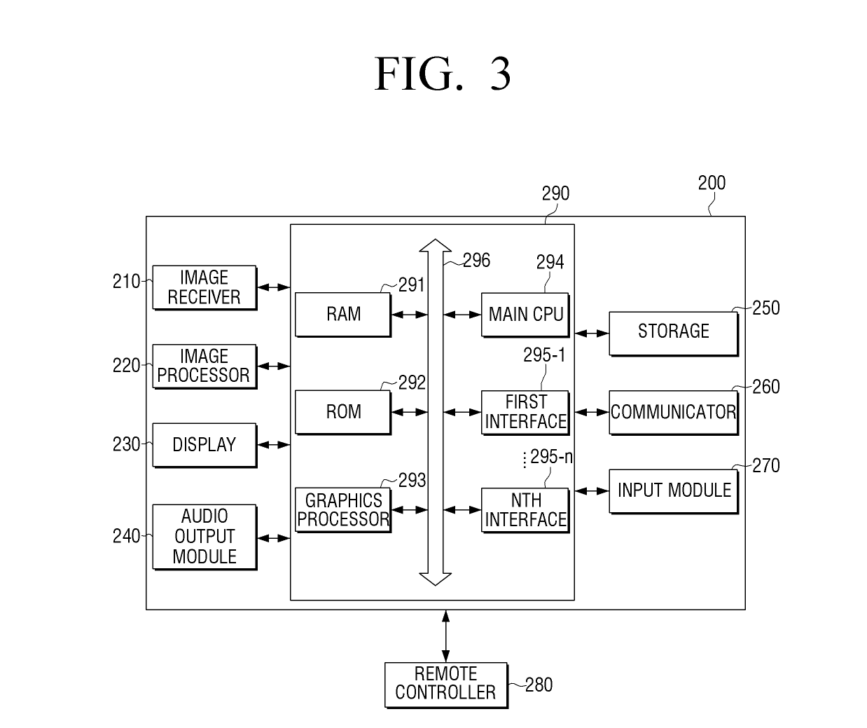

FIG. 3 is a detailed block diagram illustrating a configuration of a display apparatus 200 according to an exemplary embodiment. As illustrated in FIG. 3, the display apparatus 200 may include an image receiver 210, an image processor 220, a display 230, an audio output unit 240, a storage 250, a communicator 260, an input unit 270, and a processor 290. An external input device such as a remote controller 280 can communicate with the display apparatus to transmit user command signals.

The image receiver 210 may receive various images and visual content from an external source. Specifically, the image receiver 210 can receive broadcast content or on-demand video content from an broadcasting station, a cable provider, a satellite, an online video streaming service, an external apparatus (e.g., a digital versatile disc (DVD) player, a Blu-ray disc player, a set-top box, a dongle, etc.), a server, the Internet, etc.

The image processor 220 may perform image processing with respect to the image data acquired from the image receiver 210. The image processor 220 may perform various image processing with respect to the image data, such as decoding, scaling, noise filtering, frame rate conversion, resolution conversion, etc.

The display 230 may display an image content received from the image receiver and/or various user interface overlay graphics processed by a graphics processor 293. In particular, the display 230 may display an application execution screen along with any other image content.

The audio output module 240 may output not only various audio data processed by an audio processor (not shown) but also various alarm sounds or voice messages.

The storage 250 may store various modules to drive the display apparatus 200. The storage 250 may be any of the computer-readable storage mediums or devices discussed above. For example, the storage 250 may store software including a base module, a sensing module, a communication module, a presentation module, a web browser module, and a service module. In this case, the base module refers to a basic module which processes a signal transmitted from each hardware component included in the display apparatus 200, and transmits the processed signal to an upper-layer module. The sensing module is a module which collects information from various sensors, and analyzes and manages the collected information. The sensing module may include a face recognition module, a voice recognition module, a motion recognition module, an NFC recognition module, and so on. The presentation module is a module to compose a display screen. The presentation module may include a multimedia module for reproducing and outputting multimedia content, and a user interface (UI) rendering module for UI and graphics processing. The communication module may perform communication with other devices, systems, and services. The web browser module refers to a module which enables web browsing to access a web server. The service module may include various applications for providing various services.

As described above, the storage 250 may include various program modules, but some of the program modules may be omitted or substituted, or new modules may be added according to the type and characteristics of the display apparatus 200. For example, if the display apparatus 200 is a mobile device, such as a tablet computing device, the base module may further include a location determination module to determine global positioning system (GPS) coordinates, and the sensing module may further include touch sensors, proximity sensors, accelerometers, gyroscopes, etc.

The communicator 260 performs communication with various types of external apparatuses according to various types of communication methods. The communicator 260 may include various communication chips such as a Wi-Fi chip, a Bluetooth chip, an NFC chip, a wireless communication chip, an Infrared Data Association (IrDA) communication chip, a radio frequency (RF) communication chip, etc. In this case, the Wi-Fi chip, the Bluetooth chip, and the NFC chip may perform communication according to a Wi-Fi protocol, a Bluetooth protocol, and an NFC protocol, respectively. The NFC chip refers to a chip which operates according to the NFC protocol using a band of 13.56 MHz from among various RFID frequency bands such as 135 kHz, 13.56 MHz, 433 MHz, 860-960 MHz, 2.45 GHz, etc. When the Wi-Fi chip or the Bluetooth chip is used, a variety of connectivity information such as service set identifier (SSID) and a session key may be transmitted and/or received first, and communication may be established using the connectivity information. Then, a variety of information may be transmitted and received. The wireless communication chip refers to a chip capable of performing communication according to various communication standards such as Institute of Electrical and Electronics Engineers (IEEE), Zigbee, 3rd Generation (3G), 3rd Generation Partnership Project (3GPP), Long Term Evolution (LTE), and other preexisting or future standards and protocols yet to have established.

In particular, the communicator 260 may perform communication with the server 50. Specifically, the communicator 260 may transmit an event signal to the server 50 as the predetermined user command is issued. In addition, the communicator 260 may receive application information and application data from the server 50.

The communicator 260 may also communicate with the remote controller 280. The communication module that communicates with the remote controller 280 may be the same module that communicates with the server 50. Alternatively, the communicator 260 can have separate modules for communicating with the server 50 and the remote controller 280, respectively. For example, the communicator 260 can have a Wi-Fi chip for communicating with the server 50 and an IrDA chip for communicating with the remote controller 280.

The input module 270 may receive various user inputs and manipulations to control the display apparatus 200. In particular, the input module 270 may include various input apparatuses such as a voice input unit, a motion input unit, a pointing device, a touch screen, a console, etc. to receive user inputs.

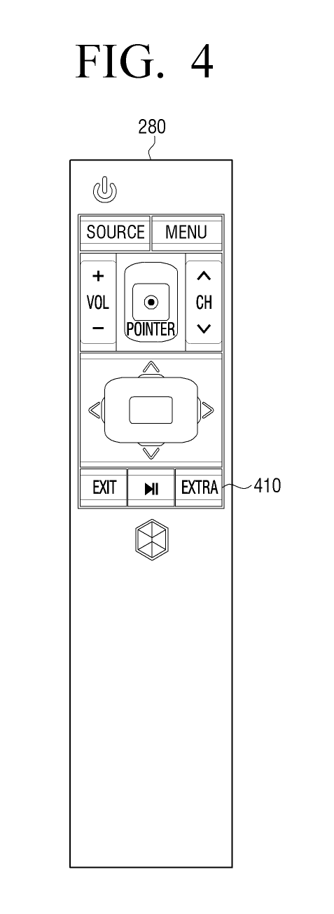

The remote controller 280 may receive a user input or manipulation to control the display apparatus 200. As the name implies, the user may input commands to the display apparatus 200 via the remote controller 280 from a remote location such as the other side of a room, another room in the building, or even outside of the building. In particular, as illustrated in FIG. 4, the remote controller 280 may include user interface elements (e.g., buttons) to control general functions of the display apparatus 200 such as a power button, a channel change button, a volume control button, etc. as well as to invoke special functions such as an extra button 410 to execute an application or service. By interacting with the user interface elements on the remote controller 280 such as buttons, the user can issue user commands to the display apparatus 200. As such, one or more user commands can be issued via the remote controller 280 by a button press, a touch, a speech utterance, a motion, etc.

The processor 290 may control the overall operations of the display apparatus 200 using various programs stored in the storage 250.

As illustrated in FIG. 3, the processor 290 may include RAM 291, ROM 292, a graphics processor 293, a main central processing unit (CPU) 294, one or more interfaces 295-1-295-n, and a bus 296. The RAM 291, the ROM 292, the graphics processor 293, the main CPU 294, and the one or more interfaces 295-1-295-n may be connected to one another through the bus 296.

The ROM 292 may store a set of commands for booting the display apparatus 200. In response to a power-on command being inputted and power being supplied, the main CPU 294 may copy the operating system (OS) stored in the storage 250 into the RAM 291 according to a command stored in the ROM 292, and boot the display apparatus 200 by executing the OS. Upon the completion of the booting process, the main CPU 294 may also copy one or more application programs stored in the storage 250 into the RAM 291, and perform various operations by executing the application programs copied into the RAM 291.

The graphics processor 293 may generate a screen including various objects such as an icon, an image, a text, etc., using a calculator (not shown) and a renderer (not shown). The calculator may calculate attribute values of objects to be displayed according to a layout of the screen, such as a coordinate value, a shape, a size, a color, etc., based on a control command received from the input module 270 or the remote controller 280. The renderer may generate a screen of various layouts including objects based on the attribute values calculated by the calculator. The screen generated by the renderer may be displayed in the display area of the display 230.

The main CPU 294 may access the storage 250 and perform the booting sequence using the OS stored in the storage 250. In addition, the main CPU 294 may perform various operations using various applications, programs, contents, data, etc. which are stored in the storage 250.

The one or more interfaces 295-1 through 295-n may be connected with the various elements described above. One of these interfaces may be a network interface connected to an external device (not shown) via a network.

In particular, when a predetermined user command is issued, for example by the user activating the extra button 410 of the remote controller 280, the processor 290 may control the communicator 260 to transmit an event signal to the server 50. Upon receiving application information from the server 50, the processor 290 may execute an application that corresponds to the application information.

FIG. 4 is an illustration of a remote controller according to an exemplary embodiment. As discussed above, the remote controller 280 may include one or more user interface elements that the user can interact with in order to issue various user commands. The remote controller 280 may be a physical hardware device or a virtual software environment. For example, the remote controller 280 can be a remote controller application running on a mobile device. The user interface elements on a virtual remote controller application can simulate the user interface elements of their physical counterparts. The remote controller 280 may include a transmitter (not shown) capable of transmitting signals to the display apparatus 200 via wireless or wired communication. Functionalities of some of the UI elements on the remote control 280 can be fixed, hardwired, or hardcoded. In other words, when those UI elements are activated the corresponding user commands being issued will, in general, trigger the same functionalities. For example, the volume up button on the remote controller 280 may only be used to raise the audio volume of the display apparatus 200. However, some other UI elements on the remote controller 280, such as the extra button 410, may be more flexible. When the user commands associated with these UI elements are issued, the display apparatus 200 may trigger different actions, services, applications, etc. based on the information received from the server 50. For example, depending on what kind of information the display apparatus 200 receives from the server 50 in response to an event signal that the display apparatus 200 transmits to the server 50, activating the extra button 410 may cause the display apparatus 200 to launch one of a number of different applications or services.

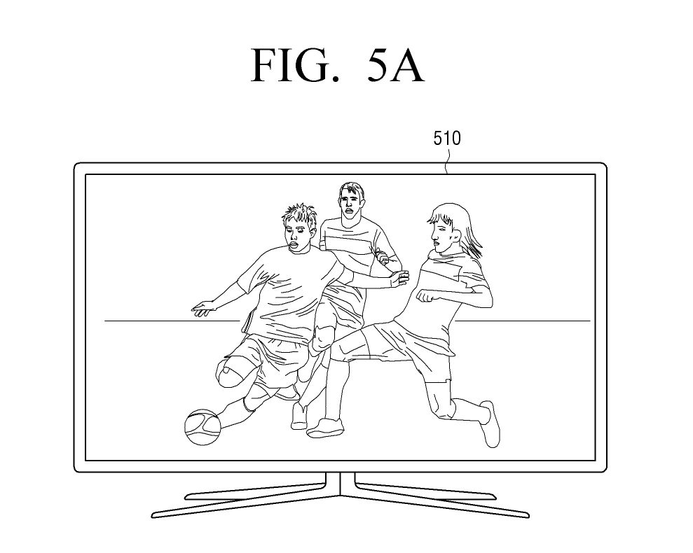

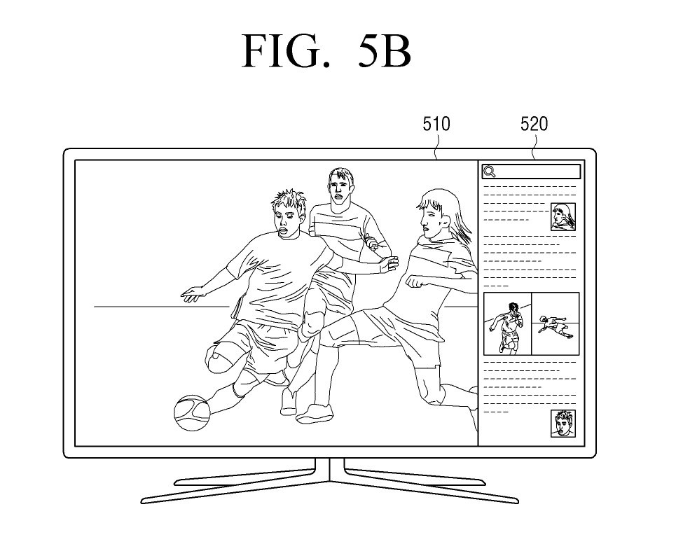

Hereinafter, various exemplary embodiments will be described with reference to FIGS. 5A through 8B.

In FIG. 5A, the processor 290 may control the display 230 to display one or more images. As used herein, the term “image” refers to one or more still images or a moving image such as a movie, a television program, a film, or like media. In this particular example, the image may be a sports broadcasting content, but is not limited thereto.

When the extra button 410 of the remote controller 280 is activated, for example by a press of the button, while the image content is being displayed on the display 230, the processor 290 may generate an event signal based on the content currently being displayed, information related to the user, a search record, and/or a viewing record. As such, the event signal may include context information related to the displayed content. For example, the context information may include an identity of the content (e.g., a name of the television show, film, event, etc. being watched), identity of a component of the content (e.g., a name of the actor starring in the show or currently shown on screen, a location being shown, what the actor is wearing, other objects being shown, etc.), dialogue, narration, closed caption, on-screen text, music, sound effect, and/or any other metadata associated with the content (time created, time aired, creators, authors, writers, genre, related media, etc.).

Specifically, the processor 290 may generate an event signal using at least one of metadata, image data, audio data, and caption data of the content being currently displayed. In addition, the processor 290 may authenticate a user who is currently watching the content. For example, the processor 290 may recognize the identity of the user by using various methods such as face recognition, iris recognition, voice recognition, personal identification number (PIN) recognition, user self-identification, etc. The processor 290 may extract user information corresponding to the recognized user and generate an event signal based on this information.

Subsequently, the processor 290 may control the communicator 260 to transmit the generated event signal to the server 50. The processor 290 may control the communicator 260 to receive application information from the server 50 in response to the event signal. In this case, the server 50 may provide the application information using at least one of content information and user information which is included in the event signal. For example, if a currently displayed content is a sporting event, the server 50 may generate application information related to a sports news application that can deliver sports-related news. The application information may also be tailored to the needs and preferences of the user of the display apparatus 200. For example, if the user has previously indicated interest in sports, the server 50 may be more likely to generate application information that is related to a sports news application. The exemplary embodiments where the server 50 generates application information will be described again later.

The processor 290 may analyze the application information received from the server 50 and execute an application corresponding to the application information. Specifically, the application information may include application ID information and version information. The processor 290 may determine which application is to be executed based on the application ID information and the version information. The processor 290 may further determine whether the determined application is already installed or not and whether the application is of an appropriate version (e.g., the latest version), and execute the corresponding application.

More specifically, the processor 290 may determine, based on application ID information, whether the application corresponding to the application information is installed at the time of the receipt of the application information. If the application corresponding to the application information is not currently installed, the processor 290 may request the server 50 to provide data regarding the application corresponding to the application information. If the data regarding the application is received from the server 50, the processor 290 may install and execute the application. The application may need to be downloaded first, for example from the server 50 or other sources, before the installation. If the application corresponding to the application information is already installed, the processor 290 may determine whether the installed application is of an appropriate version such as the latest version. If the preinstalled application is not an appropriate version, the processor 290 may request the external server 50 to provide data regarding the appropriate version of the application. If the data regarding the application is received from the server 50, the processor 290 may update the application and execute the application of the latest version. If the installed application is of the appropriate version, the processor 290 may execute the application immediately.

Meanwhile, if the application information includes a uniform resource identifier (URI) or a uniform resource locator (URL) associated with the application, the display apparatus 200 may download the application data using the URI or URL rather than downloading it from the server 50.

As described above, as the display system 200 is automatically installs and/or updates the application based on the application ID information and the version information, the user may be provided with an optimized application without the need for making any further user input.

The processor 290 may control the display 230 to display an execution screen of the application in replacement of or alongside any preexisting image content. For example, as illustrated in FIG. 5B, if a sports image content 510 is currently being displayed, the processor 290, may control the display 230 to display a sports news application 520 by overlapping the sports news application 520 with the sports image content 510. Alternatively, he application 520 can be superimposed, overlayed, or inserted as a picture-in-picture image frame. The application 520 can be displayed at the top, the bottom, the left-hand-side edge, the right-hand-side edge, the center, or one of the four corners.

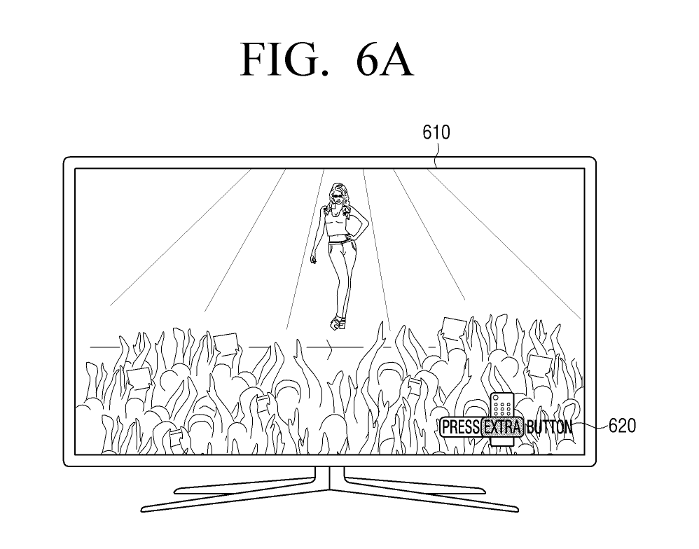

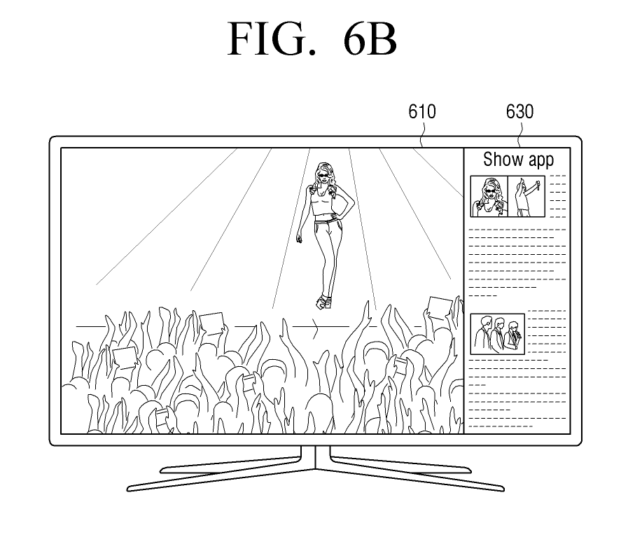

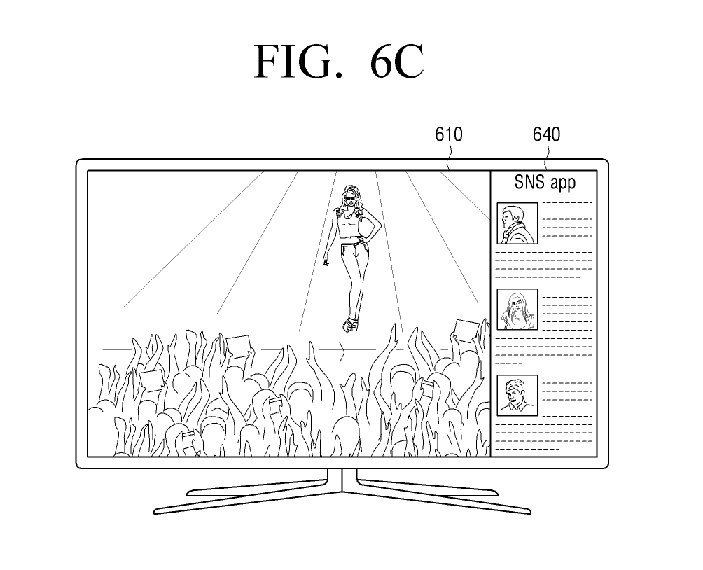

In addition, the processor 290 may control the display 230 to display a guide UI element which may guide a user to the extra button 410. Specifically, as illustrated in FIG. 6A, while an image content 610 is displayed, the processor 290 may control the display 230 to display a guide UI element 620 on a specific area (e.g., a lower right area) of the display 230.

If the extra button 410 is selected while the guide UI element 620 is displayed, the processor 290 may control the communicator 260 to transmit an event signal to the external server 50, receive first application information from the server 50, and execute the first application (e.g., an application related to a concert performance) corresponding to the first application information. In addition, as illustrated in FIG. 6B, the processor 290 may control the display 230 to display an execution screen 630 of the first application by overlapping the execution screen 630 with the image content 610.

If the extra button 410 is selected again while the image content 610 and the execution screen of the first application are displayed simultaneously, the processor 290 may control the communicator 260 to transmit another event signal to the server, receive second application information from the server 50, and execute a second application (e.g., a social media application) corresponding to the second application information. As illustrated in FIG. 6C, the processor 290 may remove the execution screen 630 of the first application and display an execution screen of the second application by overlapping the execution screen 640 with the image content 610.

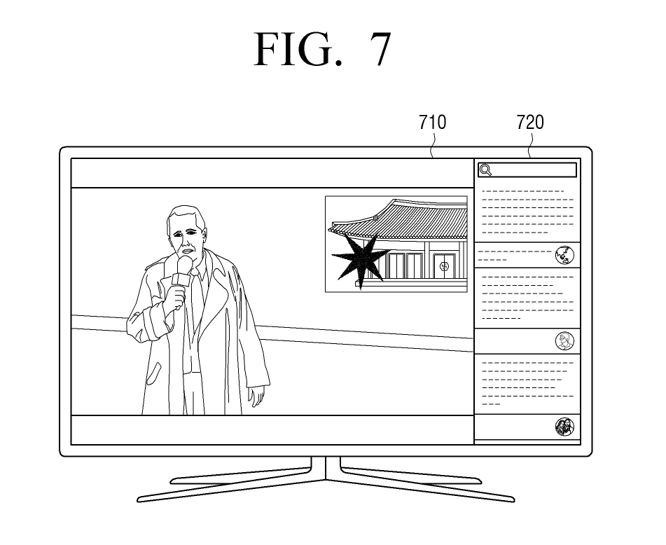

Meanwhile, in the above-described exemplary embodiment, the execution screen of an application may be displayed such that the execution screen is overlapped with an image content, but this is only an example. As illustrated in FIG. 7, the processor 290 may control the display 230 to reduce the size of an image content 710 and display an execution screen 720 of an application in a separate area.

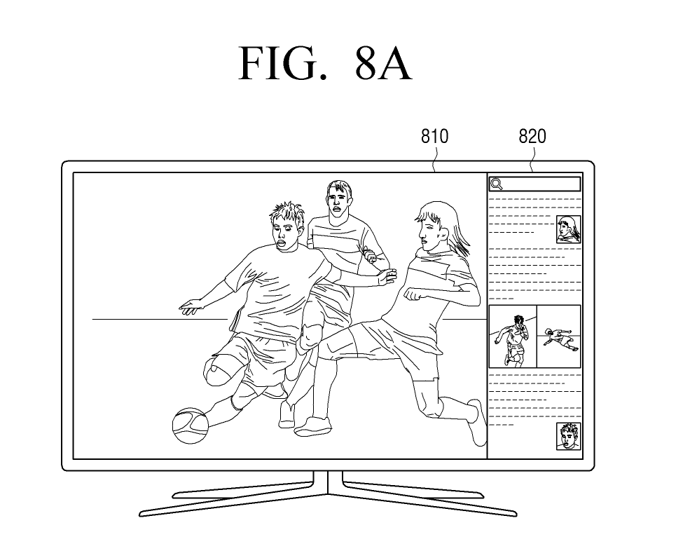

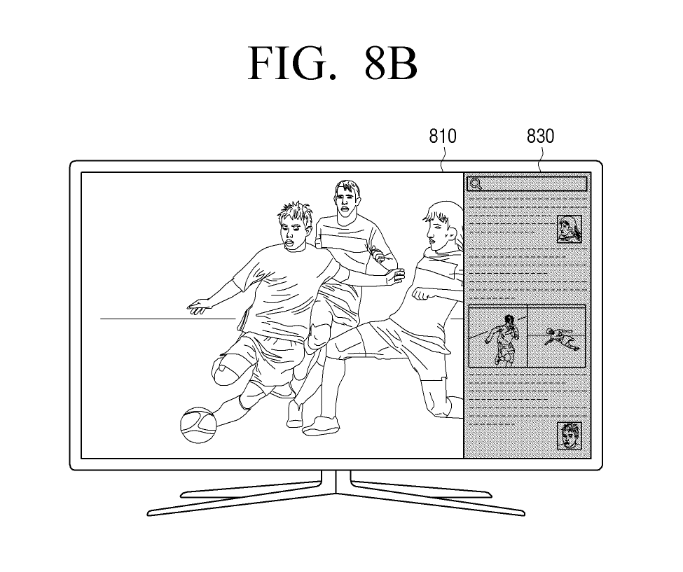

The size and aspect ratio of an execution screen of an application may be adjusted by user input. For example, as illustrated in FIG. 8A, an application execution screen 820 having a first size and a first aspect ratio may be displayed alongside the image content 810. However, as illustrated in FIG. 8B, according to a user input, an application execution screen 830 having a second size and a second aspect ratio may be displayed alongside the image content 810, where the second size is greater than the first size and the second aspect ratio is wider than the first aspect ratio.

In the above-exemplary embodiment, a specific application is executed when an extra button is selected, but this is only an example. Instead, a specific service may be provided when an extra button is selected. For example, when an extra button is selected, the display apparatus 200 may provide the user with an information providing service for providing information received from the server 50.

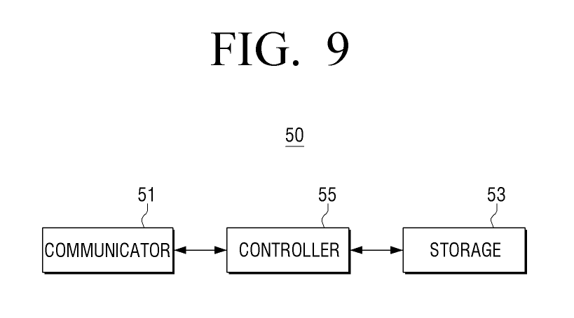

FIG. 9 is a block diagram illustrating a configuration of a server according to an exemplary embodiment. As illustrated in FIG. 9, the server 50 may include a communicator 51, a storage 53, and a controller 55.

The communicator 51 may perform communication with an external apparatus. In particular, the communicator 51 may receive an event signal from the display apparatus 100 and transmit application information and data regarding the application to the display apparatus 100.

The storage 53 may store various information and data. The storage 53 may be a computer-readable storage medium or device. In particular, the storage 53 may store application information and data related to various applications that may run on the display apparatus 100. The storage 53 may also store various types of information such as user information, content information, application matching rules, etc.

The controller 55 may control the overall operations of the server 50. In particular, the controller 55 may determine an application to be provided to a user of the display apparatus 100 in response to an event signal and generate application information that may include ID information and version information regarding the selected application.

According to an exemplary embodiment, the controller 55 may analyze an event signal and generate application information. Specifically, the event signal may include information regarding a content currently being watched by a user, the information regarding the user, the search history of the user, the viewing history of the user, etc. In particular, the controller 55 may generate the application information to be provided to the display apparatus 100 based on the content information included in the event signal. For example, if the content which is currently being watched is a television show, the controller 55 may generate information regarding an application related to the television show (e.g., the official application dedicated to the fans of the show, a shopping application related to the items shown during the show, a social media application to discuss the content of the show, etc.). On the other hand, if the content being watched currently is a news program, the controller 55 may generate information regarding an application that relates to the news content (e.g., a news application, a social media application, etc.). In addition, the controller 55 may generate the application information based on the user information included in the event signal. For example, if the area of interest of the user A is sports, the controller 55 may generate information regarding a sports-related application (e.g., a sports video streaming application, a sports news application, a sports video gaming application, etc.) for user A, and if the area of interest of user B is shopping, the controller 55 may generate information regarding a shopping application.

According to another exemplary embodiment, the controller 55 may generate application information based on a search record and a viewing record of a user who uses the display apparatus 100. For example, if a user who uses the display apparatus 100 has considerable search records regarding traveling, the controller 55 may acquire information regarding the search history of the user who uses the display apparatus 100, determine the area of interest of the user on the search history, and generate information regarding an application related to traveling (e.g., a hotel reservation application, a flight reservation application, a tour guide application, etc.) for the user.

According to another exemplary embodiment, the controller 55 may generate application information based on a popular application or a recommended application. For example, if an event signal is received, the controller 55 may generate application information regarding an application that is most popular among the general public or a group of people that are similar to the user. Upon receiving an additional event signal from the same display apparatus 100, the controller 55 may generate application information regarding the second most popular application. In addition, the controller 55 may generate application information based on the viewing history of the requesting user.

According to another exemplary embodiment, the controller 55 may change the application information at a specific time, an arbitrary time, and/or at predetermined time intervals. For example, the controller 55 may generate application information regarding a football-related application during the summer season, and generate application information regarding a basketball-related application during the winter season. The application information may also change at random intervals, thereby simulating a “surprise me” feature for the extra button 410.

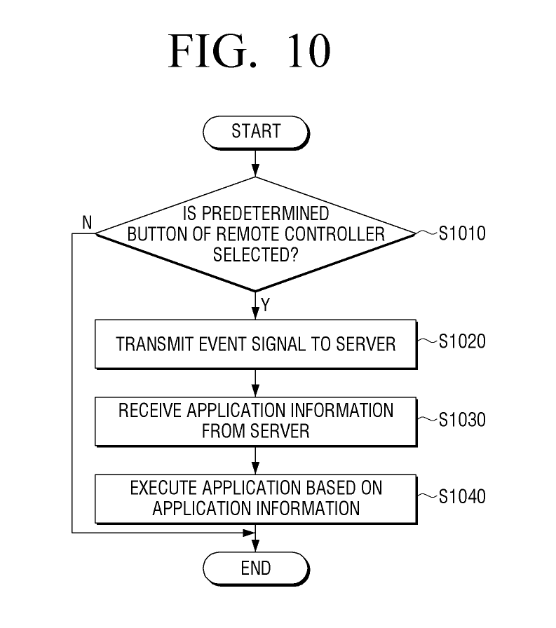

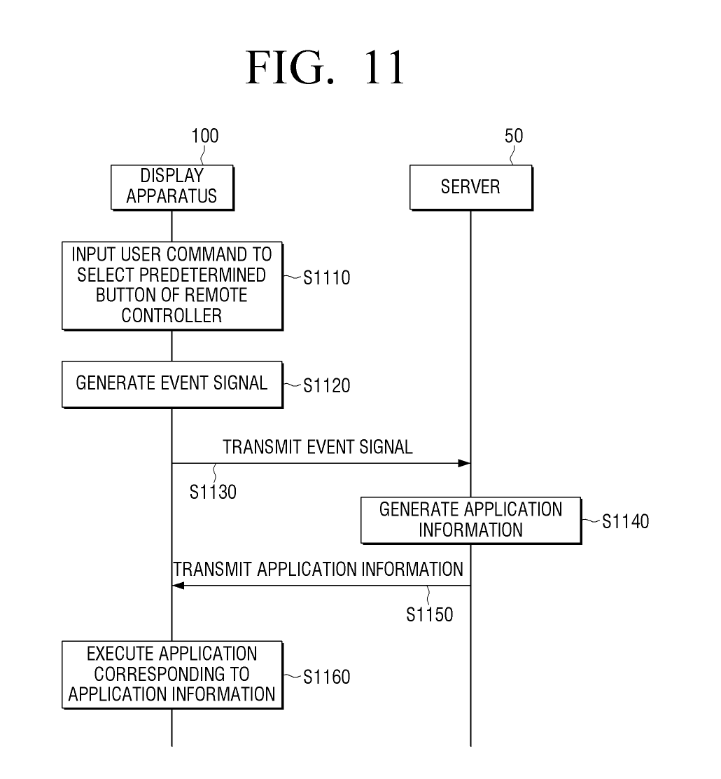

Having disclosed some basic system components and concepts, the disclosure now turns to the exemplary method embodiments shown in FIGS. 10-11. For the sake of clarity, the methods are described in terms of display apparatus 100, as shown in FIG. 1, configured to practice the method. However, the example methods can be practiced by any software or hardware components, devices, etc. heretofore disclosed, such as the display apparatus 200 of FIG. 3, etc. The steps outlined herein are exemplary and can be implemented in any combination thereof in any order, including combinations that exclude, add, or modify certain steps.

FIG. 10 is a flowchart of a method of controlling a display apparatus according to an exemplary embodiment.

First, the display apparatus 100 determines whether a predetermined button of a remote controller is selected (S1010).

If the predetermined button of the remote controller is selected (S1010-Y), the display apparatus 100 transmits an event signal to a server (S1020). In this case, the event signal may include at least one of information regarding a content which is current watched and user information.

The display apparatus 100 receives application information from the server (S1030). In this case, the application information may include application ID information, version information, etc.

The display apparatus 100 executes the application based on the application information (S1040). Specifically, the display apparatus 100 may execute the application by determining whether the application is installed and whether the application is updated based on the application ID information and the version information.

FIG. 11 is a sequence diagram illustrating a method of controlling a service providing system according to an exemplary embodiment. First, the display apparatus 100 receives a user command to select a predetermined button of a remote controller (S1110).

The display apparatus 100 generates an event signal in response to the selection of the predetermined button (S1120). In this case, the event signal may include information regarding a content which is currently watched by a user, information regarding the user, etc.

The display apparatus 100 transmits an event signal to the server 50 (S1130).

The server 50 generates application information in response to the event signal (S1140). In this case, the server 50 may generate application information using the method which is described above with reference to FIG. 9.

The server 50 transmits the generated application information to the display apparatus 100 (S1150).

The display apparatus 100 executes an application corresponding to the application information (S1160).

According to the above-described various exemplary embodiments, even if a specific service or an application corresponding to a predetermined button is terminated or discontinued, the predetermined button can continue to function. In addition, a user may be provided with various services and applications through the operation of selecting the predetermined button.

Meanwhile, the method of controlling a display apparatus according to the above-described various exemplary embodiments may be implemented as a program and provided in the display apparatus or an input apparatus. In particular, the program including the method of controlling a display apparatus may be stored in a non-transitory computer readable medium and provided therein.

The non-transitory recordable medium refers to a medium which may store data semi-permanently rather than storing data for a short time, such as register, cache, memory, etc. and is readable by an apparatus. Specifically, the above-described various applications and programs may be stored and provided in a non-transitory recordable medium such as CD, DVD, hard disk, Blu-ray disk, USB, memory card, ROM, etc.

The foregoing embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A display apparatus, comprising:
a display configured to display content;
a communication unit configured to communicate with an external apparatus;
a input unit configured to receive a user command; and
a processor configured to:
in response to the communication unit receiving a first signal corresponding to a user command being received on the input unit, control the communication unit to transmit to the external apparatus a second signal comprising the user command and context information regarding the content, and
in response to receiving, from the external apparatus, application information indicating an application to be executed, execute the application.

2. The display apparatus as claimed in claim 1, wherein the processor is further configured to, in response to the communication unit receiving the first signal, control the display to display an execution screen of the application with the content.

3. The display apparatus as claimed in claim 1, wherein the content is currently being displayed at the time the first signal is received by the communication unit, and wherein the application information is determined based on the user command and the context information regarding the content.

4. The display apparatus as claimed in claim 1, wherein the second signal further comprises information related to at least one of the user command, a user who issued the user command via the input unit, a search record associated with the user, and a viewing record associated with the user.

5. The display apparatus as claimed in claim 1, wherein the application information is updated at a predetermined time by the external apparatus.

6. The display apparatus as claimed in claim 1, wherein the processor is further configured to:
determine, based on the application information, whether the application is installed on the display apparatus,
in response to the application not being installed, request the external apparatus to provide the application, and
in response to the application being received, install the application on the display apparatus.

7. The display apparatus as claimed in claim 1, wherein the application information further indicates version information of the application.

8. The display apparatus as claimed in claim 7, wherein the processor is further configured to:
determine, based on the version information, whether a version of the application which is currently installed on the display apparatus is a latest version of the application,
in response to the version of the application not being the latest version, request the external apparatus to provide the latest version of the application, and
in response to the latest version of the application being received, update the application to the latest version.

9. A method of executing an application, the method comprising:
receiving, at a device, a first signal from an input unit associated with the device, the first signal corresponding to a user command being received at the input unit;
in response to receiving the first signal, transmitting, from the device to an external apparatus, a second signal comprising the user command and context information regarding content reproduced at the device; and
upon receiving, from the external apparatus, application information indicating an application, executing the application at the device.

10. The method as claimed in claim 9, further comprising:
displaying the content at the device,
wherein the executing comprises displaying an execution screen of the application alongside an image of the content.

11. The method as claimed in claim 9, wherein the application information is determined based on the user command and the context information.

12. The method as claimed in claim 9, wherein the second signal further comprises information related to at least one of the user command, a user issued the user command via the input unit, a search history associated with the user, and a viewing history associated with the user.

13. The method as claimed in claim 9, wherein the application information is updated at a predetermined time by the external apparatus.

14. The method as claimed in claim 9, further comprising:
determining, based on the application information, whether the application is installed on the device;
in response to the application not being installed on the device, requesting the external apparatus to provide the application; and
upon receiving the application from the external apparatus, installing the application on the device.

15. The method as claimed in claim 9, wherein the application information further indicates version information of the application.

16. The method as claimed in claim 15, further comprising:
determining, based on the version information, whether a version of the application which is currently installed on the device is a latest version of the application;
in response to the version of the application currently installed on the device not being the latest version, requesting the external apparatus to provide the latest version of the application; and
upon receiving the latest version of the application, updating the application to the latest version.

17. The method as claimed in claim 9, wherein the application is a first application, the application information is first application information, the context information is first context information, and the content is first content, the method further comprising:
receiving, at the device, a third signal from the input unit, the third signal corresponding to the user command being received at the input unit;
in response to the third signal, transmitting, from the device to the external apparatus, a fourth signal comprising the user command and second content information regarding second content reproduced at the device; and
upon receiving, from the external apparatus, second application information indicating a second application different from the first application, executing the second application.

18. The display apparatus as claimed in claim 1, wherein the input unit is remote controller.

19. The method as claimed in claim 9, wherein the input unit is remote controller.
